(19) United States
(12) Patent Application Publication
(10) Pub. No.: US 2026/0014805 A1
(43) Pub. Date: Jan. 15, 2026

(54) PHOTOCURABLE INK, INK CARTRIDGE, AND INKJET RECORDING METHOD

(71) Applicant: CANON KABUSHIKI KAISHA, Tokyo (JP)

(72) Inventors: MASANOBU OOTSUKA, Tokyo (JP); YASUHIRO AICHI, Tokyo (JP); AYANO MASHIDA, Kanagawa (JP); JUNJI ITO, Kanagawa (JP)

(21) Appl. No.: 19/334,260

(22) Filed: Sep. 19, 2025

Related U.S. Application Data
(63) Continuation of application No. PCT/JP2024/011853, filed on Mar. 26, 2024.

(30) Foreign Application Priority Data
Mar. 28, 2023 (JP) 2023-051700
Mar. 18, 2024 (JP) 2024-042925

(51) Int. Cl. B41J 11/00; B41J 2/175; C09D 11/322; C09D 11/38

(52) U.S. Cl. CPC B41J 11/00214; B41J 2/17503; C09D 11/322; C09D 11/38

(57) ABSTRACT

A photocurable ink includes a radical polymerizable compound and a photopolymerization initiator, wherein the radical polymerizable compound contains an N-vinyl compound, and at least one type of acrylic monomer selected from a group consisting of a (meth)acrylic acid ester compound and a (meth)acrylamide compound, and wherein the photocurable ink contains an aromatic secondary amine compound. An ink cartridge and a method for inkjet recording using the photocurable ink are also provided.

### CROSS-REFERENCE TO RELATED APPLICATIONS

This application is a Continuation of International Patent Application No. PCT/JP2024/011853, filed Mar. 26, 2024, which claims the benefit of Japanese Patent Applications No. 2023-051700, filed Mar. 28, 2023, and No. 2024-042925, filed Mar. 18, 2024, all of which are hereby incorporated by reference herein in their entirety.

### BACKGROUND

### Field of the Technology

The present disclosure relates to photocurable ink, an ink cartridge, and an inkjet recording method.

### Description of the Related Art

In the field of inkjet printing, particularly in the field of industrial inkjet printing, photocurable ink has become widely used due to their fast-drying properties, broad compatibility with various recording media, and being free of volatile organic compounds (VOCs).

A photocurable ink contains unsaturated organic compounds that undergo polymerization upon exposure to ultraviolet light in the presence of a photopolymerization initiator. The photopolymerization initiator contained in the photocurable ink generates radicals when irradiated with ultraviolet light. The unsaturated organic compounds polymerize through radical reactions with the generated radicals, and thus the photocurable ink is cured and fixed to a recording medium. This reaction proceeds instantaneously after irradiation with ultraviolet light, so that the photocurable ink exhibits fast-drying properties.

In addition, since a photocurable ink cures instantaneously upon exposure to ultraviolet light, it can be used to print even on a non-ink-absorptive recording medium, which does not absorb ink, such as metal, glass, ceramics, and plastic films, without deterioration in image quality. In other words, there are many recording media for which the photocurable ink can be used. Further, because all of the unsaturated organic compounds contained in the photocurable ink undergo polymerization, the ink does not contain VOCs and therefore does not release them into the atmosphere.

However, it is known that radical polymerizable compounds, typified by (meth)acrylic acid ester compounds and (meth)acrylamide compounds, which are unsaturated organic compounds, are susceptible to curing inhibition by oxygen. Thus, there is an issue that a surface exposed to the atmosphere is likely to remain sticky due to insufficient curing even after irradiation with ultraviolet light.

According to Japanese Patent Laid-Open No. 2012-25124, an inkjet recording method is described that uses an ink composition that contains a monofunctional (meth)acrylate compound having an aromatic group in combination with an N-vinyl compound such as N-vinylcaprolactam. According to Japanese Patent Laid-Open No. 2012-25124, an inkjet recording method is described in which, in addition to a process of irradiating ultraviolet light, a process of irradiating active radiation is further performed to induce secondary curing of the ink composition, thereby reducing the stickiness of the printed surface.

Here, the ink composition used in the inkjet recording method described in Japanese Patent Laid-Open No. 2012-25124 may gel during storage of the ink itself, particularly when stored under high temperature conditions.

### SUMMARY

The present disclosure is, therefore, directed to the provision of a photocurable ink that exhibits improved stickiness upon curing and has high storage stability under high temperature conditions. In addition, the present disclosure is also directed to the provision of an ink cartridge and an inkjet recording method using the above-described photocurable ink.

According to an aspect of the present disclosure, a photocurable ink includes a radical polymerizable compound and a photopolymerization initiator, wherein the radical polymerizable compound contains an N-vinyl compound, and at least one type of acrylic monomer selected from a group consisting of a (meth)acrylic acid ester compound and a (meth)acrylamide compound, and wherein the photocurable ink contains an aromatic secondary amine compound.

Features of the present disclosure will become apparent from the following description of embodiments with reference to the attached drawings.

### BRIEF DESCRIPTION OF THE DRAWINGS

FIG. 1 is a cross-sectional view schematically illustrating an embodiment of an ink cartridge according to the present disclosure.

FIG. 2A schematically illustrates an example of an inkjet recording apparatus used in an inkjet recording method according to the present disclosure and is a perspective view of a main portion of the ink jet recording apparatus.

FIG. 2B schematically illustrates an example of the inkjet recording apparatus used in the inkjet recording method according to the present disclosure and is a perspective view of a head cartridge.

### DESCRIPTION OF THE EMBODIMENTS

The present disclosure is described in further detail below with reference to various embodiments. In the present specification, a photocurable ink for inkjet printing may be simply referred to as “ink”. Unless otherwise specified, physical properties are values measured at room temperature (25° C.) and normal atmospheric pressure (1 atm). Further, terms “(meth)acrylic acid” and “(meth)acrylate” refer to “acrylic acid and methacrylic acid” and “acrylate and methacrylate”, respectively.

The inventors of the present disclosure studied photocurable inks that can reduce stickiness after curing. As a result, it was found that N-vinyl compounds used in conventional photocurable inks have an effect of reducing curing inhibition caused by oxygen. Meanwhile, it was found that, since N-vinyl compounds exhibit high reactivity with radicals and have an effect of prompting polymerization reactions, photocurable inks containing N-vinyl compounds gel in a case where they are stored under high temperature conditions.

As a result of further study based on the above-described findings, it was found that a photocurable ink containing a radical polymerizable compound, a photopolymerization initiator, and an aromatic secondary amine compound can improve its storage stability under high temperature conditions. Further, it was found that this photocurable ink can reduce stickiness when it is cured.

The radical polymerization compound that cures the photocurable ink by polymerizing in a radical reaction includes an N-vinyl compound and at least one type of acrylic monomer selected from the group containing a (meth)acrylic acid ester compound and a (meth)acrylamide compound. In addition, a photopolymerization initiator is used to cause the radical reaction of these radical polymerizable compounds. A reason why storage stability of the photocurable ink under high temperature conditions is improved by a configuration of the present disclosure is inferred to be as follows.

The photocurable ink according to the present disclosure contains an aromatic secondary amine compound. The aromatic secondary amine compound donates a secondary amine hydrogen to a radical generated from a radical polymerizable compound. This reaction can stop a radical chain reaction, so that the photocurable ink is suppressed from gelling before irradiation with ultraviolet (UV) light, and the storage stability of the photocurable ink at high temperatures is improved.

### Photocurable Ink

The photocurable ink according to the present disclosure contains a radical polymerizable compound and a photopolymerization initiator. The radical polymerizable compound contains an N-vinyl compound and at least one type of acrylic monomer selected from a group consisting of a (meth)acrylic acid ester compound and a (meth)acrylamide compound. Further, the photocurable ink contains an aromatic secondary amine compound. The photocurable ink according to the present disclosure is ink for inkjet printing. Each component contained in the photocurable ink is described below.

### <Polymerizable Monomer>

As a radical polymerizable compound, which is a polymerizable monomer in the photocurable ink according to the present disclosure, an N-vinyl compound and an acrylic monomer can be used. As the acrylic monomer, at least one type of acrylic monomer selected from a group containing a (meth)acrylic acid ester compound and a (meth)acrylamide compound can be used. The acrylic monomer described here is a general term for (meth)acrylic acid-based radical polymerizable compounds such as an acrylic acid ester compound, an acrylamide compound, a methacrylic acid ester compound, a methacrylamide compound, and the like.

The photocurable ink according to the present disclosure may contain a radical polymerizable compound other than an acrylic monomer. It is desirable that the photocurable ink contains at least one type of multifunctional radical polymerizable compound as a radical polymerizable compound.

### (N-Vinyl Compound)

Examples of N-vinyl compounds include N-vinylacetamide, 2-methyl-1-vinylimidazole, N-vinylcaprolactam, 1-vinylimidazole, 1-vinyl-2-pyrrolidone, N-vinyl methyl oxazolidinone (VMOX), 1,3-divinylimidazolidine-2-one, N-vinylpyrrolidone, and the like, but are not limited to them. Two or more types of N-vinyl compounds may be used in combination. Among them, it is desirable in terms of curing speed to contain at least one compound selected from a group consisting of N-vinylcaprolactam, N-vinyl methyl oxazolidinone, 1,3-divinylimidazolidine-2-one, and N-vinylpyrrolidone.

A content of the N-vinyl compound contained in the photocurable ink is desirably 5% by mass or more and 95% by mass or less, more desirably 10% by mass or more and 70% by mass or less, and even more desirably 20% by mass or more and 60% by mass or less based on a content of the radical polymerizable compound. By adjusting the content of the N-vinyl compound within these ranges, stickiness of the photocurable ink after curing can be reduced.

### (Acrylic Monomer)

Examples of acrylic monomers that can be used in the photocurable ink according to the present disclosure include a monofunctional (meth)acrylic acid ester compound, a monofunctional (meth)acrylamide compound, and a multifunctional (meth)acrylic acid ester compound. Among them, it is desirable that the photocurable ink contains at least one type of multifunctional acrylic monomer in terms of adjusting a polymerization speed, viscosity, and hardness after curing. Among them, it is desirable that the photocurable ink contains at least one type of multifunctional (meth)acrylic acid ester compound in terms of affinity with the N-vinyl compound.

As a (meth)acrylic acid ester compound or a (meth)acrylamide compound, any of conventionally known compounds can be used.

### (Monofunctional (Meth)acrylic Acid Ester Compound)

Exampled of monofunctional (meth)acrylic acid ester compounds include, for example, phenoxyethyl acrylate, ethyl acrylate, ethyl carbitol acrylate, acrylic acid 2-(diethylamino)ethyl, acrylic acid 3-(methoxydimethylsilyl)propyl, acrylic acid 2-(dimethylamino)ethyl, benzyl acrylate (BZA), trimethylolpropane cyclic formal acrylate, isobornyl acrylate, isobornyl methacrylate, dicyclopentanyl acrylate, cyclohexyl acrylate, 3,3,5-trimethylcyclohexyl acrylate, a-allyloxymethyl acrylate (AOMA), tetrahydrofurfuryl acrylate (THF-A), tetrahydrofurfuryl methacrylate, methacrylic acid 2-morpholinoethyl ester, mevalonic lactone methacrylate, 2-methylacrylic acid 2-oxotetrahydrofuran-3-yl, 2-(dimethylamino)ethyl acrylate, 2-ethylhexyl acrylate, tert-butyl acrylate, 2-hydroxy-3-phenoxypropyl acrylate, 2-(2-ethoxyethoxy)ethyl acrylate, 1-methylcyclopentyl acrylate, isopentyl acrylate, 1-acryloyloxyadamantane, 2-(diisopropylamino)ethyl methacrylate, 1-ethylcyclopentyl methacrylate, isopropyl methacrylate, 5-methacroyloxy-2,6-norbornane carbolactone, 2-oxotetrahydrofuran-3-yl methacrylate, (2-oxo-1,3-dioxolan-4-yl)methyl methacrylate, (3-ethyloxetan-3-yl)methyl methacrylate, 5-oxotetrahydrofuran-3-yl methacrylate, 2-(tert-butylamino)ethyl methacrylate, furfuryl methacrylate, and the like, but are not limited to them. Among them, a (meth)acrylic acid ester compound having a heterocyclic group containing a nitrogen atom or an oxygen atom is more desirable. Two or more types of these monofunctional radical polymerizable compounds may be used in combination.

### (Multifunctional (Meth)acrylic Acid Ester Compound)

Examples of multifunctional (meth)acrylic acid ester compounds include a pentaerythritol derivative, an isocyanurate derivative, a trimethylolpropane derivative, and the like, and any of these can be used.

Examples of pentaerythritol derivatives include pentaerythritol tri(meth)acrylate, pentaerythritol tetra(meth)acrylate, ethylene oxide modified pentaerythritol tri(meth)acrylate, propylene oxide modified pentaerythritol tri(meth)acrylate, ethylene oxide modified pentaerythritol tetra(meth)acrylate, propylene oxide modified pentaerythritol tetra(meth)acrylate, dipentaerythritol penta(meth)acrylate, dipentaerythritol hexa(meth)acrylate, tripentaerythritol (meth)acrylate, and the like. Among them, pentaerythritol tri(meth)acrylate, pentaerythritol tetra(meth)acrylate, dipentaerythritol penta(meth)acrylate, dipentaerythritol hexa(meth)acrylate, and tripentaerythritol (meth)acrylate are desirable.

Examples of isocyanurate derivatives include tris(2-hydroxyethyl)isocyanurate di(meth)acrylate, tris(2-hydroxyethyl)isocyanurate tri(meth)acrylate, a urethane acrylate type isocyanurate derivative obtained by reacting an isocyanurate type polyisocyanate with a multifunctional pentaerythritol derivative or a multifunctional trimethylol derivative having a hydroxyl group, and the like, thereby introducing multifunctionality via a urethane bond. Among them, tris(2-hydroxyethyl)isocyanurate tri(meth)acrylate and the urethane acrylate type isocyanurate derivative are desirable.

Further, examples of trimethylolpropane derivatives include trimethylolpropane tri(meth)acrylate, propoxylated trimethylolpropane tri(meth)acrylate, ethylene oxide modified trimethylolpropane triacrylate, propylene oxide modified trimethylolpropane, ditrimethylolpropane tetraacrylate, and the like. Among them, trimethylolpropane tri(meth)acrylate and ditrimethylolpropane tetraacrylate are desirable as the trimethylolpropane derivatives.

### (Monofunctional (Meth)acrylamide Compound)

Examples of monofunctional (meth)acrylamide compounds include, for example, N,N-dimethylacrylamide (DMAA), N-isopropylacrylamide (NIPAM), N-propylacrylamide, N-diacetone acrylamide, N-[2-(diethylamino)ethyl]acrylamide, N-[3-(dimethylamino)propyl]acrylamide, N,N-diethylacrylamide (DEAA), acryloylmorpholine (ACMO), acryloylpiperidin, N-(methoxymethyl)acrylamide, N-(isobutoxymethyl)acrylamide, N-(butoxymethyl)acrylamide, 3-acryloyl-2-oxazolidinone, N-[2-(dimethylamino)ethyl]acrylamide, N-(2-hydroxyethyl)acrylamide, N-(hydroxymethyl)acrylamide, N,N-dimethylmethacrylamide, N-isopropylmethacrylamide, N-methylmethacrylamide, N-(methoxymethyl)methacrylamide, N-[3-(dimethylamino)propyl]methacrylamide, N-(2-hydroxypropyl)methacrylamide, N-butylacrylamide, N-(3-methoxypropyl)acrylamide, and the like, but are not limited to them. Two or more types of these monofunctional radical polymerizable compounds may be used in combination.

### (Multifunctional (Meth)acrylamide Compound)

Examples of multifunctional (meth)acrylamide compounds include, for example, N-[tris(3-acrylamidopropoxymethyl)methyl]acrylamide, N,N-bis(2-acrylamidoethyl)acrylamide, N,N′-[oxybis(2,1-ethanediyloxy-3,1-propanediyl)]bisacrylamide, N,N′-1,2-ethanediylbis{N-[2-(acryloylamino)ethyl]acrylamide}, and the like, but are not limited to them.

### <Photopolymerization Initiator>

Examples of photopolymerization initiators include an aromatic ketone compound, an oxime ester compound, an acylphosphine oxide compound, a thioxanthone compound, a benzophenone compound, a benzoate compound, an aromatic onium salt compound, an organic peroxide, a thio compound (a thiophenyl group-containing compound and the like), an α-aminoalkylphenone compound, a hexaarylbiimidazole compound, a borate compound, an azinium compound, a metallocene compound, an active ester compound, a compound containing a carbon-halogen bond, an alkylamine compound, and the like.

In addition, radical generators described in Japanese Patent Laid-Open No. 2018-35369, Japanese Patent Laid-Open No. 2018-39265, and the like can also be used. Among them, an α-hydroxyketone compound, an α-aminoalkylphenone compound, an oxime ester compound, an acylphosphine oxide compound, and a benzophenone compound are desirable, and an oxime ester compound is more desirable. A photoradical polymerization initiator can be used alone or in combination of two or more types thereof. A content of the photopolymerization initiator contained in the photocurable ink is desirably 1.0% by mass or more and 10.0% by mass or less, and more desirably 2.0% by mass or more and 8.0% by mass or less, based on a content of the radical polymerizable compound. Two or more types of photopolymerization initiators can be used in combination as necessary.

Examples of aromatic ketone compounds include acetophenone, 2,2-diethoxyacetophenone, 2,2-dimethoxy-2-phenylacetophenone, 2,2′-pheny-p-tert-butyltrichloro acetophenone, p-tert-butyldichloro acetophenone, methyl benzoylformate, N,N′-tetramethyl-4,4′-diaminobenzophenone (Michler's Ketone), 1-hydroxycyclohexyl phenyl ketone, 1-[4-(2-hydroxyethoxy)-phenyl]-2-hydroxy-2-methylpropane, 2-benzyl-2-dimethylamino-1-(4-morpholinophenyl)-butanone-1, 2-methyl-[4-(methylthio)phenyl]-2-morpholino-1-propane, 2-(dimethylamino)-2-[(4-methylphenyl)methyl]-1-[4-(4-morpholinyl)phenyl]-1-butanone, and the like.

Examples of α-hydroxyketone compounds include 2-hydroxy-2-methyl-1-phenyl-1-propanone, 2-hydroxy-1-{4-[4-(2-hydroxy-2-methyl-propionyl)-benzyl]-phenyl}-2-methyl-propane-1-one, 1-hydroxycyclohexyl phenyl ketone, and the like.

Examples of α-aminoalkylphenone compounds include 2-benzyl-2-dimethylamino-1-(4-morpholinophenyl)-butanone-1,2-methyl-[4-(methylthio)phenyl]-2-morpholino-1-propane, 2-(dimethylamino)-2-[(4-methylphenyl)methyl]-1-[4-(4-morpholinyl)phenyl]-1-butanone, and the like.

Examples of oxime ester compounds include 1-[4-(phenylthio)phenyl]-1,2-octanedione 2-(O-benzoyloxime), ethanone, 1-[9-ethyl-6-(2-methylbenzoyl)-9H-carbazol-3-yl]-, 1-(O-acetyloxime), (9-ethyl-6-nitro-9H-carbazol-3-yl)-(4-((1-methoxypropane-2-yl)oxy)-2-methylphenyl)methanone-o-acetyloxime, 1-[4-[[4-(2-hydroxyethoxy)phenyl]thio]phenyl-1]-1,2-propanedione-2-(O-acetyloxime), and the like.

Examples of acylphosphine oxide compounds include 2,4,6-trimethylbenzoyl diphenylphosphine oxide, bis(2,4,6-trimethylbenzoyl)-diphenylphosphine oxide, and the like.

Examples of benzoin alkyl ether compounds include benzoin methyl ether, benzoin ethyl ether, benzoin butyl ether, benzoin isopropyl ether, and the like.

Examples of benzoin ether compounds include methylbenzoin, ethylbenzoin, and the like.

Examples of thioxanthone compounds include 2-chlorothioxanthone, 2,4-diethylthioxanthone, isopropylthioxanthone, 2-methylthioxanthone, and the like.

Examples of benzophenone compounds include benzophenone, 4-methylbenzophenone, 4-phenylbenzophenone, 4-(4-methylphenylthio)benzophenone, 4,4′-bis(diethylamino)benzophenone, and the like.

Examples of benzoate compounds include ethyl-4-(dimethylamino)-benzoate, ethylhexyl-4-dimethylaminobenzoate, methyl-o-benzoylbenzoate, 3-methylbutyl p-(dimethylamino) benzoate, and the like.

### <Aromatic Secondary Amine Compound>

The photocurable ink according to the present disclosure contains an aromatic secondary amine compound. An aromatic secondary amine compound acts as a polymerization inhibitor in the photocurable ink. Examples of aromatic secondary amine compounds include, for example, phenothiazine, 3,7-dioctylphenothiazine, 6-ethoxy-2,2,4-trimethyl-1,2-dihydroquinoline, polymerized 2,2,4-trimethyl-1,2-dihydroquinoline, 4,4′-dioctyldiphenylamine, 4,4′-dicumyl-diphenylamine, di-tert-butyl-diphenylamine, 3,7-dicumyl phenothiazine, 2-oxydiphenylamine, bis-a-methylbenzyl phenothiazine, N-isopropyl-N-phenyl-p-phenylenediamine, N-(1,3-dimethylbutyl)-N′-phenyl-p-phenylenediamine, N-(1-methylheptyl)-N′-phenyl-p-phenylenediamine, N,N′-diphenyl-p-phenylenediamine, N,N′-di-2-naphthyl-p-phenylenediamine, N,N′-di-2-naphthyl-1,2-phenylenediamine, N,N′-di-sec-butyl-1,4-phenylenediamine, 4-methyl-N1-(3-phenylpropyl)-1,2-phenylenediamine, N-phenyl-o-phenylenediamine, N,N,N′-triphenyl-1,4-phenylenediamine, and the like.

Among the aromatic secondary amine compounds, phenylenediamine derivatives such as N-isopropyl-N-phenyl-p-phenylenediamine, N-(1,3-dimethylbutyl)-N′-phenyl-p-phenylenediamine, N-(1-methylheptyl)-N′-phenyl-p-phenylenediamine, N,N′-diphenyl-p-phenylenediamine, N,N′-di-2-naphthyl-p-phenylenediamine, N,N′-di-2-naphthyl-1,2-phenylenediamine, N,N′-di-sec-butyl-1,4-phenylenediamine, 4-methyl-N1-(3-phenylpropyl)-1,2-phenylenediamine, N-phenyl-o-phenylenediamine, and N,N,N′-triphenyl-1,4-phenylenediamine are desirable. Further, among the phenylenediamine derivatives, N,N′-di-2-naphthyl-1,2-phenylenediamine, N,N′-di-sec-butyl-1,4-phenylenediamine, 4-methyl-N1-(3-phenylpropyl)-1,2-phenylenediamine, N-phenyl-o-phenylenediamine, and N,N,N′-triphenyl-1,4-phenylenediamine are desirable. The phenylenediamine derivative has a significantly higher effect of stabilizing N-vinyl compounds than other structures, so that it is presumed that the phenylenediamine derivative improves the storage stability of the photocurable ink under high temperature conditions.

If these aromatic secondary amine compounds are blended in an excessive amount, a curing reaction may be inhibited, whereas if they are blended in an insufficient amount, sufficient storage stability may not be acquired. Thus, if the polymerizable monomer contained in the photocurable ink is 100 parts by mass, the aromatic secondary amine compound is desirably 0.001 parts by mass or more and 1 parts by mass or less, and more desirably 0.01 parts by mass or more and 0.5 parts by mass or less.

### <Coloring Material>

The photocurable ink according to the present disclosure may contain a coloring material. As a coloring material, known inorganic pigment, organic pigment, and dye can be used. In terms of light resistance, the coloring material is desirably a pigment. As the pigment, a pigment containing at least one selected from a group consisting of a black pigment, a cyan pigment, a magenta pigment, a yellow pigment, and a white pigment can be used.

Examples of the black pigments that can be used include, for example, carbon black manufactured by a furnace method or a channel method and the like.

Examples of the white pigments that can be used include, for example, alkaline earth metal sulfate such as barium sulfate, alkaline earth metal carbonate such as calcium carbonate, finely divided silica, silica-based materials such as synthetic silicate, calcium silicate, alumina, hydrated alumina, titanium oxide, zinc oxide, talc, clay, and the like.

Examples of the yellow pigments that can be used include, for example, pigment yellow 1, pigment yellow 2, pigment yellow 3, pigment yellow 12, pigment yellow 13, pigment yellow 14, pigment yellow 16, pigment yellow 17, pigment yellow 73, pigment yellow 74, pigment yellow 75, pigment yellow 83, pigment yellow 93, pigment yellow 95, pigment yellow 97, pigment yellow 98, pigment yellow 114, pigment yellow 120, pigment yellow 128, pigment yellow 129, pigment yellow 138, pigment yellow 150,pigment yellow 151, pigment yellow 154, pigment yellow 155, pigment yellow 180, and the like, which are Pigment Yellow-based pigments.

Examples of the magenta pigments that can be used include, for example, pigment red 5, pigment red 7, pigment red 12, pigment red 48 (Ca), pigment red 48 (Mn), pigment red 57 (Ca), pigment red 57:1, pigment red 112, pigment red 122, pigment red 123, pigment red 168, pigment red 184, pigment red 202, pigment violet 19, and the like, which are Pigment Red-based pigments.

Examples of the cyan pigments that can be used include, for example, pigment blue 1, pigment blue 2, pigment blue 3, pigment blue 15, pigment blue 15:3, pigment blue 15:4, pigment blue 16, pigment blue 22, pigment blue 60, vat blue 4, vat blue 60, and the like, which are Pigment Blue-based pigments.

In addition, various inorganic and organic pigments can be used as necessary, taking into consideration physical properties, and the like. A content of the pigment contained in the photocurable ink is desirably 0.50% by mass or more and 10% by mass or less, and more desirably 1% by mass or more and 7% by mass or less based on the total mass of the photocurable ink.

### <Other Additive>

The photocurable ink according to the present disclosure may further contain higher fatty acid-based, silicone-based, fluorine-based, and other surfactants, a polymeric pigment dispersant containing a polar group, and the like, as necessary.

In addition to the above-described additives, the photocurable ink may further contain various additives such as a surfactant, a pH adjuster, an anti-rust agent, a preservative, an antifungal agent, an antioxidant, a reduction inhibitor, an evaporation accelerator, a chelating agent, and the like, as necessary.

### <Method for Preparing Photocurable Ink>

The photocurable ink according to the present disclosure may be prepared by dispersing the above-described radical polymerizable compound, aromatic secondary amine compound, and the like together with the coloring material, if necessary. Further, the polymerization initiator may then be added and gently mixed until dissolved, and then, the mixture is pressure filtered using, for example, a membrane filter with a pore size of 5 micrometers (μm) (manufactured by Sartorius), so that the photocurable amine compound according to the present disclosure can be prepared. The method for preparing the photocurable ink is not particularly limited and is not limited to the above-described preparation method.

### <Physical Properties of Photocurable Ink>

The viscosity of the photocurable ink according to the present disclosure at 25° C. is desirably 3 mPa·s or more and 200 mPa·s or less, and more desirably 3 mPa·s or more and 100 mPa·s or less. In a case where a commercially available inkjet ejection head, such as a NITROX manufactured by Xaar, is used, the head temperature can be raised, and ejection is possible as long as the viscosity is 100 mPa·s or less so that the viscosity is not limited to this range as long as the viscosity can be sufficiently reduced by heating.

### Ink Cartridge

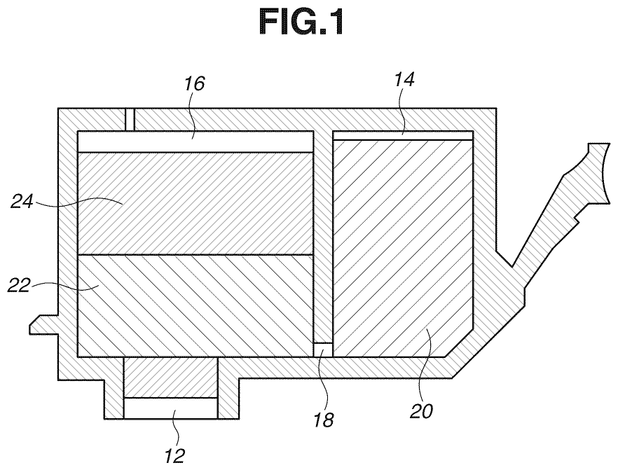

An ink cartridge according to the present disclosure includes ink and an ink storage unit that stores the ink. The ink stored in the ink storage unit is the photocurable ink according to the present disclosure described above. FIG. 1 is a cross-sectional view schematically illustrating an embodiment of the ink cartridge according to the present disclosure. As illustrated in FIG. 1, a bottom surface of the ink cartridge is provided with an ink supply port 12 for supplying the ink to a recording head. The inside of the ink cartridge is the ink storage unit that stores the ink. The ink storage unit is composed of an ink storage chamber 14 and an absorber storage chamber 16, which are communicated with each other via a communication port 18. The absorber storage chamber 16 is also communicated with the ink supply port 12. The ink storage chamber 14 stores liquid ink 20, and the absorber storage chamber 16 stores absorbers 22 and 24 that retain the ink in an impregnated state. The ink storage unit may not include the ink storage chamber that stores the liquid ink and may be configured to retain the entire amount of ink stored therein using an absorber. Further, the ink storage unit may not include the absorbers and may be configured to store the entire amount of ink in a liquid state. Furthermore, the ink cartridge may be configured to include the ink storage unit and the recording head.

### Inkjet Recording Method

An inkjet recording method according to the present disclosure includes an ink application process and an irradiation process. The ink application process is a process of ejecting the above-described photocurable ink according to the present disclosure from an inkjet type recording head and applying the ink to a recording medium. The irradiation process is a process of irradiating the ink applied to the recording medium with ultraviolet light, and the photopolymerization initiator generates radicals, thereby causing polymerization of the radical polymerizable compound. In the inkjet recording method according to the present disclosure, the irradiation process is performed after the ink application process.

Examples of the methods for ejecting ink can include a method for applying mechanical energy to the ink and a method for applying thermal energy to the ink. According to the present disclosure, it is desirable to adopt the method for ejecting the ink by applying mechanical energy thereto.

A wavelength of ultraviolet light irradiated to cure the photocurable ink may be a wavelength that can react with the photopolymerization initiator contained in the photocurable ink and may have a peak wavelength of, for example, 365 nanometers (nm) or more and 425 nm or less. The radical polymerizable compound undergoes a polymerization reaction by being irradiated with ultraviolet light, and thus the photocurable ink can be cured and fixed. As an ultraviolet light source, an ultraviolet light emitting diode (UV-LED) or a metal halide lamp can be used. By using a small and lightweight UV-LED, it is possible to reduce the size and energy consumption of the ink jet recording apparatus, and images can be formed with high productivity. Further, since the UV-LED has excellent variability in exposure conditions, it is possible to set suitable exposure conditions according to the photocurable ink, and images can be formed with high productivity.

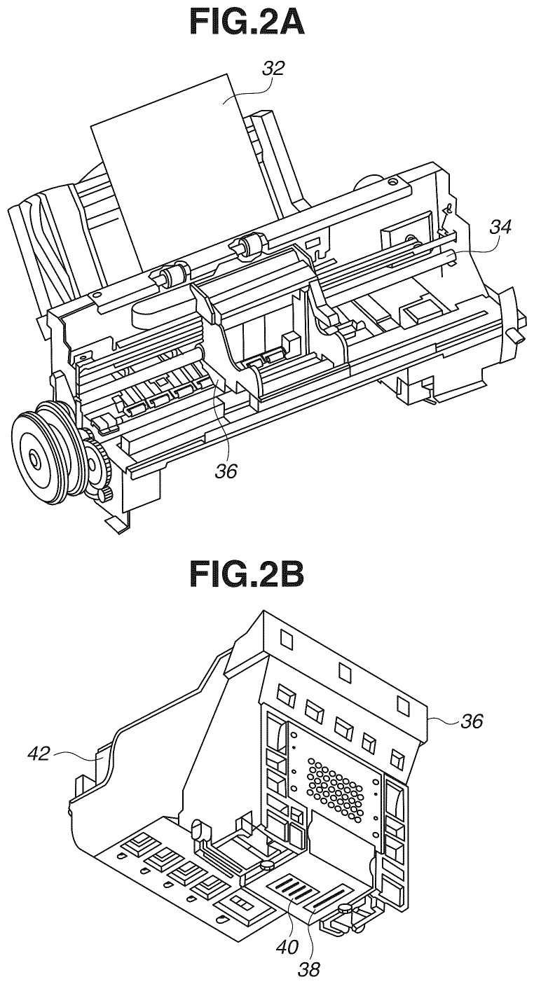

FIGS. 2A and 2B schematically illustrate an example of the ink jet recording apparatus used in the inkjet recording method according to the present disclosure. FIG. 2A is a perspective view of a main part of the ink jet recording apparatus, and FIG. 2B is a perspective view of a head cartridge. The ink jet recording apparatus is provided with a conveyance unit (not illustrated) that conveys a recording medium 32 and a carriage shaft 34. A head cartridge 36 can be mounted on the carriage shaft 34. The head cartridge 36 includes recording heads 38 and 40 and is configured so that an ink cartridge 42 is set therein. While the head cartridge 36 is conveyed along the carriage shaft 34 in a main scanning direction, ink (not illustrated) is ejected from the recording heads 38 and 40 toward the recording medium 32. Then, the recording medium 32 is conveyed by the conveyance unit (not illustrated) in a sub-scanning direction, so that an image is recorded on the recording medium 32.

### EXAMPLES

The present disclosure is described in more details below with reference to Examples and Comparative Examples. However, the present disclosure is not limited by the examples in any way as long as the essential features of the present disclosure are maintained. The units “parts” and “%” for component amounts are based on weight, unless otherwise specified.

### Preparation of Pigment Dispersion

### (Preparation of Yellow Pigment Dispersion)

Yellow pigment: C.I. pigment yellow 155 (product name “NOVOPERM YELLOW 4G-01”, manufactured by Clariant) 30.00 parts
Surfactant (product name “DISPERBYK-168”, manufactured by BYK Japan KK) 20.00 parts
(Meth)acrylic acid ester compound: Phenoxyethyl acrylate (product name “Viscoat #192”, manufactured by Osaka Organic Chemical Industry Co., Ltd.) 50.00 parts

The above-described components were stirred to obtain the yellow pigment dispersion. The pigment dispersion was prepared by placing the mixture into a dispersing machine (Motor Mill M50, manufactured by Eiger) and dispersing it for 8 hours at a peripheral speed of 9 m/s using zirconia beads having a diameter of 0.65 mm.

### (Preparation of Magenta Pigment Dispersion)

Magenta pigment: C.I. pigment violet 19 (product name “CINQUASIA MAGENTA RT-355D”, manufactured by Ciba Specialty Chemicals Co., Ltd.) 30.00 parts
Surfactant (product name “DISPERBYK-168”, manufactured by BYK Japan KK) 20.00 parts
(Meth)acrylic acid ester compound: Phenoxyethyl acrylate (product name “Viscoat #192”, manufactured by Osaka Organic Chemical Industry Co., Ltd.) 50.00 parts

The above-described components were stirred under the same dispersion conditions as in the preparation of the yellow pigment dispersion to obtain the magenta pigment dispersion.

### (Preparation of Cyan Pigment Dispersion)

Cyan pigment: C.I. pigment blue 15:3 (product name “IRGALITE BLUE GLO”, manufactured by Ciba Specialty Chemicals Co., Ltd.) 30.00 parts
Surfactant (product name “DISPERBYK-168”, manufactured by BYK Japan KK) 20.00 parts
(Meth)acrylic acid ester compound: Phenoxyethyl acrylate (product name “Viscoat #192”, manufactured by Osaka Organic Chemical Industry Co., Ltd.) 50.00 parts

The above-described components were stirred under the same dispersion conditions as in the preparation of the yellow pigment dispersion to obtain the cyan pigment dispersion.

### (Preparation of Black Pigment Dispersion)

Black pigment: Carbon black (product name “SPECIAL BLACK 250”, manufactured by Degussa) 40.00 parts
Surfactant (product name “DISPERBYK-168”, manufactured by BYK Japan KK) 20.00 parts
(Meth)acrylic acid ester compound: Phenoxyethyl acrylate (product name “Viscoat #192”, manufactured by Osaka Organic Chemical Industry Co., Ltd.) 35.00 parts

The above-described components were stirred under the same dispersion conditions as in the preparation of the yellow pigment dispersion to obtain the black pigment dispersion.

### Preparation of Photocurable Ink

### (Method for Preparing Photocurable Ink According to Example 1)

Black pigment dispersion 15.00 parts
N-vinyl compound: N-vinylcaprolactam (manufactured by Tokyo Chemical Industry Co., Ltd.) 49.97 parts
(Meth)acrylic acid ester compound: Phenoxyethyl acrylate (product name “Viscoat #192”, manufactured by Osaka Organic Chemical Industry Co., Ltd.) 10.00 parts
(Meth)acrylic acid ester compound: Cyclic trimethylolpropane formal acrylate (product name “Viscoat #200”, manufactured by Osaka Organic Chemical Industry Co., Ltd.) 10.00 parts
(Meth)acrylic acid ester compound: Ethyl carbitol acrylate (product name “Viscoat #190”, manufactured by Osaka Organic Chemical Industry Co., Ltd.) 10.00 parts
(Meth)acrylic acid ester compound: Trimethylolpropane triacrylate (product name “Viscoat #295”, manufactured by Osaka Organic Chemical Industry Co., Ltd.) 2.00 parts
Photopolymerization initiator: Bis(2,4,6-trimethylbenzoyl)-phenylphosphine oxide (product name “Omnirad 819”, manufactured by IGM Resins B.V.) 3.00 parts
Aromatic secondary amine compound: Phenothiazine (manufactured by FUJIFILM Wako Pure Chemical Corporation) 0.03 parts

The above-described components were mixed and stirred to obtain the photocurable ink according to Example 1.

### (Method for Preparing Photocurable Ink According to Examples 2 to 39 and Comparative Examples 1 to 5)

Table 1 lists symbols corresponding to each component. The photocurable inks according to Examples 2 to 39 and Comparative Examples 1 to 5 were prepared using the same preparation method as that of Example 1, except that the components listed in Tables 2-1 to 2-4 were used. Unless otherwise specified, the numerical values in the tables represent the amount (in parts by mass) of each component.

TABLE 1
Table of Symbols Corresponding to Each Component

| | | Type | Symbol |
|---|---|---|---|
| Radical | N-vinyl | N-Vinylcaprolactam (manufactured by Tokyo Chemical | A-1 |
| Polymerizable | compound | Industry) | |
| Compound | | N-Vinylpyrrolidone (manufactured by Tokyo Chemical | A-2 |
| | | Industry) | |
| | | N-Vinylmethyloxazolidinone (manufactured by BASF) | A-3 |
| | | 1,3-Divinylimidazolidin-2-one (manufactured by BASF) | A-4 |
| | (Meth) | Phenoxyethyl Acrylate (Product name “Viscoat #192”, | B-1 |
| | Acrylic Acid | manufactured by Osaka Organic Chemical Industry) | |
| | Ester | Cyclic Trimethylolpropane Formal Acrylate (Product | B-2 |
| | Compound | name “Viscoat #200”, manufactured by Osaka Organic | |
| | | Chemical Industry) | |
| | | 3,3,5-Trimethylcyclohexyl Acrylate (Product name | B-3 |
| | | “Viscoat #196”, manufactured by Osaka Organic | |
| | | Chemical Industry) | |
| | | Ethyl Carbitol Acrylate (Product name “Viscoat #190”, | B-4 |
| | | manufactured by Osaka Organic Chemical Industry) | |
| | | Isobornyl Acrylate (manufactured by Osaka Organic | B-5 |
| | | Chemical Industry) | |
| | | Dimethylol-Tricyclodecane Diacrylate | B-6 |
| | | (Product name “Light Acrylate DCP-A”, manufactured | |
| | | by Kyoeisha Chemical Co./Ltd.) | |
| | (Meth) | Trimethylolpropane Triacrylate (Product name “Viscoat | B-7 |
| | Acryl | #295”, manufactured by Osaka Organic Chemical | |
| | amide | Industry) | |
| | Compound | Pentaerythritol Tetraacrylate (Product name “Viscoat | |
| | | #300”, manufactured by Osaka Organic Chemical | B-8 |
| | | Industry) | |
| | | Tris(2-Hydroxyethyl)Isocyanurate Triacrylate (Product | B-9 |
| | | name “SR368 NS”; manufactured by Sartomer) | |
| | | Acryloylmorpholine (Product name “ACMO”, | C-1 |
| | | manufactured by KJ Chemicals) | |
| | | Hydroxyethyl Acrylamide (manufactured by Tokyo | C-2 |
| | | Chemical Industry) | |

| Vinyl Ether Compound | Triethylene Glycol Divinyl Ether (manufactured by | D |
|---|---|---|
| | Sigma Aldrich) | |
| Photopolymerization Initiator | Bis(2,4,6-Trimethylbenzoyl)-Diphenylphosphine Oxide | |
| | (Product name “Omnirad 819”, manufactured by IGM | E |
| | Resins B.V.) | |
| (i) Aromatic Secondary Amine | Phenothiazine (manufactured by FUJIFILM Wako Pure | i-1 |
| other than Phenylenediamine | Chemical Corporation) | |
| Derivative | 3,7-Dioctylphenothiazine (manufactured by Seiko | i-2 |
| | Chemical) | |
| | 6-Ethoxy-2,2,4-Trimethyl-1,2-Dihydroquinoline | i-3 |
| | (manufactured by Tokyo Chemical Industry) | |
| | Polymerized 2,2,4-Trimethyl-1,2-Dihydroquinoline | i-4 |
| | (Product name “ANTAGE RD”, manufactured by | |
| | Kawaguchi Chemical Industry) | |
| | 4,4′-Dioctyldiphenylamine (manufactured by OUCHI | i-5 |
| | SHINKO CHEMICAL INDUSTRIAL) | |
| | 4,4′-Dicumyl-Diphenylamine (manufactured by Tokyo | i-6 |
| | Chemical Industry) | |
| | Di-Tert-Butyl-Diphenylamine (manufactured by Tokyo | i-7 |
| | Chemical Industry) | |
| | 3,7-Dicumyl Phenothiazine (manufactured by Seiko | i-8 |
| | Chemical) | |
| | 2-Oxydiphenylamine (manufactured by Seiko Chemical) | i-9 |
| | Bis-α-Methylbenzyl Phenothiazine (manufactured by | i-10 |
| | Kawaguchi Chemical Industry) | |
| (ii) Aromatic Secondary | N-Isopropyl-N-Phenyl-p-Phenylenediamine | ii-1 |
| Amine, which is | (manufactured by Tokyo Chemical Industry) | |
| Phenylenediamine Derivative | N-(1,3-Dimethylbutyl)-N′-Phenyl-p-Phenylenediamine | ii-2 |
| | (manufactured by Tokyo Chemical Industry) | |
| | N-(1-Methylheptyl)-N′-Phenyl-p-Phenylenediamine | ii-3 |
| | (manufactured by Tokyo Chemical Industry) | |
| | N,N′-Diphenyl-p-Phenylenediamine (manufactured by | ii-4 |
| | Tokyo Chemical Industry) | |
| | Bis-a-Methylbenzyl Phenothiazine (manufactured by | ii-5 |
| | Kawaguchi Chemical Industry) | |
| | N,N′-di-2-Naphthyl-p-Phenylenediamine (manufactured | ii-6 |
| | by Tokyo Chemical Industry) | |
| | N,N′-di-sec-Butyl-1,4-Phenylenediamine (manufactured | ii-7 |
| | by Tokyo Chemical Industry) | |
| | 4-Methyl-N1-(3-Phenylpropyl)-1,2-Phenylenediamine | ii-8 |
| | (manufactured by Tokyo Chemical Industry) | |
| | N-Phenyl-o-Phenylenediamine (manufactured by Tokyo | ii-9 |
| | Chemical Industry) | |
| | N,N,N′-Triphenyl-1,4-Phenylenediamine (manufactured | ii-10 |
| | by Tokyo Chemical Industry) | |
| (iii) Polymerization Inhibitor | 1-Butylhydroquinone (manufactured by FUJIFILM Wako | iii-1 |
| other than Aromatic | Pure Chemical Corporation) | |
| Secondary Amine | N-Nitroso-N-Phenylhydroxylamine Aluminium Salt | iii-2 |
| | (manufactured by FUJIFILM Wako Pure Chemical | |
| | Corporation) | |

TABLE 2-1
Preparation and Properties of Ink

| | Example | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| Black | 15.00 | | | | 15.00 | 15.00 | 15.00 | 15.00 | 15.00 | 15.00 | 15.00 | 15.00 |
| Pigment | | | | | | | | | | | | |
| Dispersion | | | | | | | | | | | | |
| Cyan | | 15.00 | | | | | | | | | | |
| Pigment | | | | | | | | | | | | |
| Dispersion | | | | | | | | | | | | |
| Magenta | | | 15.00 | | | | | | | | | |
| Pigment | | | | | | | | | | | | |
| Dispersion | | | | | | | | | | | | |
| Yellow | | | | | | | | | | | | |
| Pigment | | | | 15.00 | | | | | | | | |
| Dispersion | | | | | | | | | | | | |
| A-1 | 49.97 | 49.97 | 49.97 | 49.97 | 49.90 | 49.70 | 49.90 | 49.90 | | | 49.90 | 49.90 |
| A-2 | | | | | | | | | 49.90 | | | |
| A-3 | | | | | | | | | | 49.90 | | |
| B-1 | 10.00 | 10.00 | 10.00 | 10.00 | 10.00 | 10.00 | | | 10.00 | 10.00 | | |
| B-2 | 10.00 | 10.00 | 10.00 | 10.00 | 10.00 | 10.00 | | | 10.00 | 10.00 | | |
| B-3 | | | | | | | 8.00 | 8.00 | | | | |
| B-4 | 10.00 | 10.00 | 10.00 | 10.00 | 10.00 | 10.00 | | | 10.00 | 10.00 | | |
| B-5 | | | | | | | 17.00 | 17.00 | | | | |
| B-6 | | | | | | | 5.00 | 5.00 | | | | |
| B-7 | 2.00 | 2.00 | 2.00 | 2.00 | 2.00 | 2.00 | | | 2.00 | 2.00 | 2.00 | 2.00 |
| B-8 | | | | | | | 2.00 | | | | | |
| B-9 | | | | | | | | 2.00 | | | | |
| C-1 | | | | | | | | | | | 30.00 | |
| C-2 | | | | | | | | | | | | 30.00 |
| E | 3.00 | 3.00 | 3.00 | 3.00 | 3.00 | 3.00 | 3.00 | 3.00 | 3.00 | 3.00 | 3.00 | 3.00 |
| i-1 | 0.03 | 0.03 | 0.03 | 0.03 | 0.10 | 0.30 | 0.10 | 0.10 | 0.10 | 0.10 | 0.10 | 0.10 |
| Content of | 57.3 | 55.9 | 55.9 | 55.9 | 57.3 | 57.2 | 57.3 | 57.3 | 57.3 | 57.3 | 57.3 | 57.3 |
| N-vinyl | | | | | | | | | | | | |
| compounds | | | | | | | | | | | | |
| based on | | | | | | | | | | | | |
| content of | | | | | | | | | | | | |
| radical | | | | | | | | | | | | |
| polymerizable | | | | | | | | | | | | |
| compounds | | | | | | | | | | | | |
| (%) | | | | | | | | | | | | |

TABLE 2-2
Preparation and Properties of Ink

| | Example | | | | | | | | | | | |
|---|---|---|---|---|---|---|---|---|---|---|---|---|
| | 13 | 14 | 15 | 16 | 17 | 18 | 19 | 20 | 21 | 22 | 23 | 24 |
| Black | 15.00 | 15.00 | 15.00 | 15.00 | 15.00 | 15.00 | 15.00 | 15.00 | 15.00 | 15.00 | 15.00 | 15.00 |
| Pigment | | | | | | | | | | | | |
| Dispersion | | | | | | | | | | | | |
| A-1 | 79.90 | 59.90 | 39.90 | 29.90 | 19.90 | 9.90 | 4.90 | 49.90 | 49.90 | 49.90 | 49.90 | 49.90 |
| B-1 | | 8.00 | 15.00 | 20.00 | 20.00 | 25.00 | 25.00 | 10.00 | 10.00 | 10.00 | 10.00 | 10.00 |
| B-2 | | 6.00 | 10.00 | 15.00 | 20.00 | 20.00 | 25.00 | 10.00 | 10.00 | 10.00 | 10.00 | 10.00 |
| B-3 | | | | | | | | | | | | |
| B-4 | | 6.00 | 15.00 | 15.00 | 20.00 | 25.00 | 25.00 | 10.00 | 10.00 | 10.00 | 10.00 | 10.00 |
| B-5 | | | | | | | | | | | | |
| B-6 | | | | | | | | | | | | |
| B-7 | 2.00 | 2.00 | 2.00 | 2.00 | 2.00 | 2.00 | 2.00 | 2.00 | 2.00 | 2.00 | 2.00 | 2.00 |
| B-8 | | | | | | | | | | | | |
| B-9 | | | | | | | | | | | | |
| E | 3.00 | 3.00 | 3.00 | 3.00 | 3.00 | 3.00 | 3.00 | 3.00 | 3.00 | 3.00 | 3.00 | 3.00 |
| i-1 | 0.10 | 0.10 | 0.10 | 0.10 | 0.10 | 0.10 | 0.10 | | | | | |
| i-2 | | | | | | | | 0.10 | | | | |
| i-3 | | | | | | | | | 0.10 | | | |
| i-4 | | | | | | | | | | 0.10 | | |
| i-5 | | | | | | | | | | | 0.10 | |
| i-6 | | | | | | | | | | | | 0.10 |
| i-7 | | | | | | | | | | | | |
| i-8 | | | | | | | | | | | | |
| i-9 | | | | | | | | | | | | |
| i-10 | | | | | | | | | | | | |
| Content of | 91.7 | 68.7 | 45.8 | 34.3 | 22.8 | 11.4 | 5.6 | 57.3 | 57.3 | 57.3 | 57.3 | 57.3 |
| N-vinyl | | | | | | | | | | | | |
| compounds | | | | | | | | | | | | |
| based on | | | | | | | | | | | | |
| content of | | | | | | | | | | | | |
| radical | | | | | | | | | | | | |
| polymerizable | | | | | | | | | | | | |
| compounds | | | | | | | | | | | | |
| (%) | | | | | | | | | | | | |

TABLE 2-3
Preparation and Properties of Ink

| | Example | | | | | | | | |
|---|---|---|---|---|---|---|---|---|---|
| | 25 | 26 | 27 | 28 | 29 | 30 | 31 | 32 | 33 |
| Black Pigment | 15.00 | 15.00 | 15.00 | 15.00 | 15.00 | 15.00 | 15.00 | 15.00 | 15.00 |
| Dispersion | | | | | | | | | |
| A-1 | 49.90 | 49.90 | 49.90 | 49.90 | 49.90 | 49.90 | 49.90 | 49.90 | 49.90 |
| B-1 | 10.00 | 10.00 | 10.00 | 10.00 | 10.00 | 10.00 | 10.00 | 10.00 | 10.00 |
| B-2 | 10.00 | 10.00 | 10.00 | 10.00 | 10.00 | 10.00 | 10.00 | 10.00 | 10.00 |
| B-3 | | | | | | | | | |
| B-4 | 10.00 | 10.00 | 10.00 | 10.00 | 10.00 | 10.00 | 10.00 | 10.00 | 10.00 |
| B-5 | | | | | | | | | |
| B-6 | | | | | | | | | |
| B-7 | 2.00 | 2.00 | 2.00 | 2.00 | 2.00 | 2.00 | 2.00 | 2.00 | 2.00 |
| B-8 | | | | | | | | | |
| B-9 | | | | | | | | | |
| E | 3.00 | 3.00 | 3.00 | 3.00 | 3.00 | 3.00 | 3.00 | 3.00 | 3.00 |
| i-7 | 0.10 | | | | | | | | |
| i-8 | | 0.10 | | | | | | | |
| i-9 | | | 0.10 | | | | | | |
| i-10 | | | | 0.10 | | | | | |
| ii-1 | | | | | 0.10 | | | | |
| ii-2 | | | | | | 0.10 | | | |
| ii-3 | | | | | | | 0.10 | | |
| ii-4 | | | | | | | | 0.10 | |
| ii-5 | | | | | | | | | 0.10 |
| Content of N- | 57.3 | 57.3 | 57.3 | 57.3 | 57.3 | 57.3 | 57.3 | 57.3 | 57.3 |
| vinyl compounds | | | | | | | | | |
| based on content | | | | | | | | | |
| of radical | | | | | | | | | |
| polymerizable | | | | | | | | | |
| compounds (%) | | | | | | | | | |

TABLE 2-4
Preparation and Properties of Ink

| | Example | | | | | | Comparative Example | | | | |
|---|---|---|---|---|---|---|---|---|---|---|---|
| | 34 | 35 | 36 | 37 | 38 | 39 | 1 | 2 | 3 | 4 | 5 |
| Black Pigment | 15.00 | 15.00 | 15.00 | 15.00 | 15.00 | 15.00 | 15.00 | 15.00 | 15.00 | 15.00 | 15.00 |
| Dispersion | | | | | | | | | | | |
| A-1 | 49.90 | 49.90 | 49.90 | 49.90 | 49.90 | | 50.00 | | | 49.90 | 49.90 |
| A-4 | | | | | | 49.90 | | | | | |
| B-1 | 10.00 | 10.00 | 10.00 | 10.00 | 10.00 | 10.00 | 10.00 | 30.00 | 10.00 | 10.00 | 10.00 |
| B-2 | 10.00 | 10.00 | 10.00 | 10.00 | 10.00 | 10.00 | 10.00 | 30.00 | 10.00 | 10.00 | 10.00 |
| B-3 | | | | | | | | | | | |
| B-4 | 10.00 | 10.00 | 10.00 | 10.00 | 10.00 | 10.00 | 10.00 | 19.90 | 10.00 | 10.00 | 10.00 |
| B-5 | | | | | | | | | | | |
| B-6 | | | | | | | | | | | |
| B-7 | 2.00 | 2.00 | 2.00 | 2.00 | 2.00 | 2.00 | 2.00 | 2.00 | 2.00 | 2.00 | 2.00 |
| B-8 | | | | | | | | | | | |
| B-9 | | | | | | | | | | | |
| D | | | | | | | | | 49.90 | | |
| E | 3.00 | 3.00 | 3.00 | 3.00 | 3.00 | 3.00 | 3.00 | 3.00 | 3.00 | 3.00 | 3.00 |
| i-1 | | | | | | | | 0.10 | 0.10 | | |
| ii-1 | | | | | | | | | | | |
| ii-2 | | | | | | | | | | | |
| ii-3 | | | | | | | | | | | |
| ii-4 | | | | | | | | | | | |
| ii-5 | | | | | | | | | | | |
| ii-6 | 0.10 | | | | | | | | | | |
| ii-7 | | 0.10 | | | | 0.10 | | | | | |
| ii-8 | | | 0.10 | | | | | | | | |
| ii-9 | | | | 0.10 | | | | | | | |
| ii-10 | | | | | 0.10 | | | | | | |
| iii-1 | | | | | | | | | | 0.10 | |
| iii-2 | | | | | | | | | | | 0.10 |
| Content of | 57.3 | 57.3 | 57.3 | 57.3 | 57.3 | 57.3 | 57.3 | 0 | 0 | 57.3 | 57.3 |
| N-vinyl | | | | | | | | | | | |
| compounds | | | | | | | | | | | |
| based on | | | | | | | | | | | |
| content of | | | | | | | | | | | |
| radical | | | | | | | | | | | |
| polymerizable | | | | | | | | | | | |
| compounds (%) | | | | | | | | | | | |

### Image Formation and Evaluation

### (Image Formation)

Recording was performed on a recording medium using the photocurable inks prepared according to Examples 1 to 39 and Comparative Examples 1 to 5 and the ink jet recording apparatus having a piezoelectric inkjet nozzle. Further, a linear irradiation type UV-LED irradiation device (GC77 (irradiation wavelength: 365 nm), manufactured by HAMAMATSU) was mounted on a part adjacent to the recording head of the ink jet recording apparatus. In the ink jet recording apparatus, the recording duty of an image recorded under conditions of a resolution of 600 dpi×600 dpi and applying 8 droplets of ink (3.8 ng) to a unit area of 1/600 inch× 1/600 inch is defined as 100%. Using this ink jet recording apparatus, a solid image with 100% duty was printed in one pass on a polyester (PET) film (product name “Lumirror 75E20”, manufactured by TORAY). Immediately after that, the film was irradiated once with ultraviolet light at a conveyor speed of 100 meters per minute (m/min). Separately, an accumulated light amount under the same conditions was measured using an integrating ultraviolet light meter (C9536-01, manufactured by HAMAMATSU), and found to be 100 mJ/cm².

According to the present disclosure, in evaluation criteria for each evaluation item described below, “AA”, “A”, and “B” represent acceptable levels, and “C” represents an unacceptable level. Evaluation results are listed in Table 3.

### (Stickiness Evaluation)

A printed material on which an image was formed was evaluated by tactile inspection according to the following criteria.
AA: No stickiness felt on the printed surface at all.
A: Slight stickiness felt on the printed surface, but not problematic in practical use.
B: Some stickiness felt on the printed surface, but almost no practical issues.
C: Noticeable stickiness felt on thee printed surface, causing practical problems.
   (Evaluation of Storage Stability under High Temperature Conditions)

The photocurable inks prepared according to Examples 1 to 39 and Comparative Examples 1 to 5 were stored in a temperature-controlled chamber at 80° C. for two weeks, and the viscosity of the photocurable ink before and after aging were measured, and a rate of change in viscosity was calculated. The viscosity was measured using an E-type viscometer (RE-85L, manufactured by Toki Sangyo Co., Ltd.) under the conditions of 25° C. and a rotation speed of 50 rpm and, evaluation was conducted based on the following criteria.
AA: Viscosity change rate within ±10% after two weeks of storage.
A: Viscosity change rate within ±10% after one week of storage, but not within ±10% after two weeks of storage.
B: Viscosity change rate within ±10% after three days of storage, but not within ±10% after one week of storage.
C: Viscosity change rate exceeds ±10% before three days of storage, but not within ±10% after three days of storage.

TABLE 3
Evaluation Result

| | | | Evaluation of |
|---|---|---|---|
| | | | Storage Stability |
| | | | under High |
| | | Stickiness | Temperature |
| | | Evaluation | Conditions |
| Example | 1 | AA | B |
| | 2 | AA | B |
| | 3 | AA | B |
| | 4 | AA | B |
| | 5 | AA | B |
| | 6 | AA | B |
| | 7 | AA | B |
| | 8 | AA | B |
| | 9 | AA | B |
| | 10 | AA | B |
| | 11 | AA | B |
| | 12 | AA | B |
| | 13 | B | B |
| | 14 | A | B |
| | 15 | AA | B |
| | 16 | AA | B |
| | 17 | AA | B |
| | 18 | A | B |
| | 19 | B | B |
| | 20 | AA | B |
| | 21 | AA | B |
| | 22 | AA | B |
| Example | 23 | AA | B |
| | 24 | AA | B |
| | 25 | AA | B |
| | 26 | AA | B |
| | 27 | AA | B |
| | 28 | AA | B |
| | 29 | AA | A |
| | 30 | AA | A |
| | 31 | AA | A |
| | 32 | AA | A |
| | 33 | AA | A |
| | 34 | AA | AA |
| | 35 | AA | AA |
| | 36 | AA | AA |
| | 37 | AA | AA |
| | 38 | AA | AA |
| | 39 | AA | A |
| Comparative | 1 | AA | C |
| Example | 2 | C | B |
| | 3 | C | C |
| | 4 | AA | C |
| | 5 | AA | C |

The disclosure of the present embodiment includes following configurations and methods.

### (Configuration 1)

A photocurable ink includes a radical polymerizable compound and a photopolymerization initiator,
wherein the radical polymerizable compound contains:
an N-vinyl compound; and
at least one type of acrylic monomer selected from a group consisting of a (meth)acrylic acid ester compound and a (meth)acrylamide compound, and
wherein the photocurable ink contains an aromatic secondary amine compound.

### (Configuration 2)

The photocurable ink according to Configuration 1, wherein the radical polymerizable compound contains at least one type of multifunctional radical polymerizable compound.

### (Configuration 3)

The photocurable ink according to Configuration 1, wherein a content of the N-vinyl compound contained in the photocurable ink is 5% by mass or more and 95% by mass or less based on a content of the radical polymerizable compound.

### (Configuration 4)

The photocurable ink according to Configuration 1, wherein the N-vinyl compound contains at least one selected from a group consisting of N-vinylcaprolactam, N-vinyl methyl oxazolidinone, 1,3-divinylimidazolidin-2-one, and N-vinylpyrrolidone.

### (Configuration 5)

The photocurable ink according to Configuration 1, wherein the aromatic secondary amine compound contains at least one type of phenylenediamine derivative.

### (Configuration 6)

The photocurable ink according to Configuration 5, wherein the phenylenediamine derivative contains at least one selected from a group consisting of N,N′-di-2-naphthyl-p-phenylenediamine, N,N′-di-sec-butyl-1,4-phenylenediamine, 4-methyl-N1-(3-phenylpropyl)-1,2-phenylenediamine, N-phenyl-o-phenylenediamine, and N,N,N′-triphenyl-1,4-phenylenediamine.

### (Configuration 7)

The photocurable ink according to Configuration 1 further includes a coloring material.

### (Configuration 8)

An ink cartridge includes ink and an ink storage unit configured to store the ink, wherein the ink is the photocurable ink according to any one of Configurations 1 to 7.

### (Method 1)

A method for inkjet recording includes:
ejecting the photocurable ink according to any one of Configurations 1 to 7 from an inkjet type recording head and applying the ink to a recording medium; and
irradiating the photocurable ink ejected on the recording medium with ultraviolet light.

The present disclosure is not limited to the above-described embodiments, and various modifications and changes can be made without departing from the spirit and the scope of the present disclosure. Therefore, the following claims are attached in order to publicize the scope of the present disclosure.

According to the present disclosure, it is possible to provide photocurable ink that exhibits improved stickiness upon curing and has high storage stability under high temperature conditions. Further, according to the present disclosure, an ink cartridge and an inkjet recording method using this photocurable ink can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A photocurable ink comprising a radical polymerizable compound and a photopolymerization initiator,
wherein the radical polymerizable compound contains:
an N-vinyl compound; and
at least one type of acrylic monomers selected from a group consisting of a (meth)acrylic acid ester compound and a (meth)acrylamide compound, and
wherein the photocurable ink contains an aromatic secondary amine compound.

2. The photocurable ink according to claim 1, wherein the radical polymerizable compound contains at least one type of multifunctional radical polymerizable compound.

3. The photocurable ink according to claim 1, wherein a content of the N-vinyl compound contained in the photocurable ink is 5% by mass or more and 95% by mass or less based on a content of the radical polymerizable compound.

4. The photocurable ink according to claim 1, wherein the N-vinyl compound contains at least one selected from a group consisting of N-vinylcaprolactam, N-vinyl methyl oxazolidinone, 1,3-divinylimidazolidin-2-one, and N-vinylpyrrolidone.

5. The photocurable ink according to claim 1, wherein the aromatic secondary amine compound contains at least one type of phenylenediamine derivative.

6. The photocurable ink according to claim 5, wherein the phenylenediamine derivative contains at least one selected from a group consisting of N,N′-di-2-naphthyl-p-phenylenediamine, N,N′-di-sec-butyl-1,4-phenylenediamine, 4-methyl-N1-(3-phenylpropyl)-1,2-phenylenediamine, N-phenyl-o-phenylenediamine, and N,N,N′-triphenyl-1,4-phenylenediamine.

7. The photocurable ink according to claim 1, further comprising a coloring material.

8. An ink cartridge comprising ink and an ink storage unit configured to store the ink,
wherein the ink is the photocurable ink according to claim 1.

9. A method for inkjet recording, the method comprising:
ejecting the photocurable ink according to claim 1 from an inkjet type recording head and applying the ink to a recording medium; and
irradiating the photocurable ink ejected on the recording medium with ultraviolet light.
